(19) United States
(12) Patent Application Publication
(10) Pub. No.: US 2004/0213634 A1
(43) Pub. Date: Oct. 28, 2004

(54) Fastener, method of making it, and its use

(76) Inventors: Hans-Gerhard Kortmann, Vechelde (DE); Joachim Schneider, Ehringhausen-Katzenfurt (DE)

Correspondence Address: HARNESS, DICKEY & PIERCE, P.L.C., P.O. BOX 828, BLOOMFIELD HILLS, MI, 48303, US

(21) Appl. No.: 10/751,337

(22) Filed: Jan. 2, 2004

Related U.S. Application Data
(63) Continuation of application No. PCT/EP02/06952, filed on Jun. 24, 2002.

(30) Foreign Application Priority Data
Jul. 2, 2001 (DE) 101 31 510.4

(51) Int. Cl. F16D 1/00

(52) U.S. Cl. 403/408.1

(57) ABSTRACT

The invention relates to a fastener particularly for fixing at least one flat component at a spacing from a carrier member, comprising a base member which has a supporting face and a fastening face, and a shank which is arranged on the supporting face of the base member and is suitable for fixing the flat component, the fastening face being smaller than the supporting face. The fastener according to the invention is preferable for fixing at least one optionally thin-walled component with a predeterminable spacing to a carrier member, particularly when the carrier member is made of a metallic material. The carrier member may for example be a container wall or a car body component.

### CROSS-REFERENCE TO RELATED APPLICATIONS

This application is a continuation application of PCT International Application PCT/EP02/06952 which was filed on Jun. 24, 2002. PCT International Application PCT/EP02/06952 claims the benefit of German application DE 101 31 510.4, filed Jul. 2, 2001. The disclosure of the above applications is incorporated herein by reference.

### FIELD OF THE INVENTION

The present invention relates to a fastener, particularly for fixing at least one flat component to a carrier member with a spacing, a method of making it, and a use.

### BACKGROUND & SUMMARY OF THE INVENTION

For maintenance or safety reasons, for example, it is necessary in various applications for the wall of a container or a car body component to be boxed in as fully as possible or clad with a component such as a refractory wall. In the event of high thermal stress, for example a fire, the wall would prevent the respective carrier member from undergoing corresponding premature ageing, which is prejudicial to safety. A refractory wall of this type is preferably made of a non-flammable material, and it makes no difference whether the wall is rigid, structured or flexible. The problem arises that the component has to be suitably fastened to carrier members, some of which have very complex shapes. Some known fasteners extend partly through the carrier member, but this may possibly make them act as heat bridges passing through to the space bounded by the carrier member.

Known fastening means are therefore mostly welded to the carrier by the so-called projection welding method and show only limited transmission, for example of torque, owing to the spot-type connection. Moreover this welding method requires a counter-force structure and thus accessibility from two sides of the carrier member in order to fix the fastening means.

On this basis the object of the invention is to provide a fastener suitable for spaced fixing or mounting of at least one component, for example a refractory wall, to a carrier member. In particular the fixing of the fastener to the carrier member must take place from one side only. The mounting of a plurality of, for example, thin components must additionally be facilitated and made possible largely without observing any bearing tolerances. A method and a use for such a fastener must further be provided.

The problem is solved by a fastener with the features of claim 1 and a method of making it according to the features of claim 13 or 14. A use is also stated in the features of claim 15. Other advantageous embodiments of the invention which may be used singly or in combination are the subject of the respectively appended claims.

The fastener according to the invention, particularly for fixing at least one flat component to a carrier member particularly with a definable or defined spacing, comprises a base member which has a supporting face and a fastening face, and a shank which may be arranged on the supporting face of the base member and is suitable for fixing the flat component. The fastener is characterised in that the fastening face is smaller than the supporting face. The supporting face enables the flat component to lie against a relatively large face, which is advantageous particularly for thin metal sheets and does not necessarily exclude the mounting of components with offset holes.

The base member is preferably made of a metallic material, and the supporting face and fastening face are preferably arranged on opposite sides of the fastener.

The fastener preferably has its fastening face welded to the carrier. In an application to thin metal sheets the weld is advantageously stiffened. The annular flange further has the advantage that it can be welded with considerably less power consumption than when generic fasteners are welded by the known projection welding process. Dispensing with the welded projections, i.e. spot-type connections, in particular advantageously allows high torques to be transmitted and advantageously only requires access from one side, in contrast with the necessary counter-force structure in projection welding. Capital costs are thus sometimes considerably lower than in the known projection welding process.

In a preferred embodiment of the fastener the supporting face is rotationally symmetrical and has one diameter, and the fastening face is annular. It is particularly advantageous for the annular fastening face to have an internal diameter and an external diameter, the external diameter being equal to the diameter of the supporting face. The rotationally symmetrical form of the fastener advantageously helps particularly to avoid mounting errors in respect of the base member. The structure of the base member with a constant external diameter and diameter ensures that its external shape is cylindrical; such a shape can be chosen particularly with a view to suitable supports for feed means such a robots.

An alternative proposal is that the fastening face should be polygonal, thus giving the base member a polygonal-type external profile. Fasteners thus shaped are particularly suitable for use as anti-torsion devices for other attachments and for supporting and treating with a welding gun.

In another embodiment the fastening face is smaller than 80% of the supporting face, particularly smaller than 70% and preferably smaller than 65% of it. In the case described above where the base member has an annular fastening face, this results in the formation of a relatively large cavity internal that member. The fastening face is nevertheless large enough permanently to ensure the correct fitting and fixing of the base member onto the carrier member.

In a further embodiment the base member has a height between 3 and 10 mm in the direction of its axis of symmetry. In a preferred arrangement, starting from the fastening face, the base member has a cross-section or a cross-sectional area smaller than the supporting face over at least 20%, particularly at least 40% and preferably at least 50% of the height. The height of the base member substantially defines the spacing between the flat component in the mounted state and the carrier member. The given percentage range within which the base member has a reduced cross-sectional area relative to the supporting face substantially determines the height of the cavity which is formed with an annular fastening face. The proportion has to be chosen, firstly so that the least possible material is required to produce the base member, and secondly so that the stability and strength of the supporting face are not prejudiced.

In another embodiment the fastener is of modular, particularly two-part construction. This means, for example, that the base member and shank are not joined together until a stage in the assembly process. This advantageously makes the design of such a fastener more flexible and also allows different methods of fixing or clamping the flat component to the supporting face of the base member.

In yet another embodiment means are provided for positioning the shank on the supporting face of the base member, and the shank is connected to the base member preferably by a jointing technique. Such positioning means are, for example recesses, edges, stops and the like, preferably substantially corresponding to the cross-section of the shank. They assist in any fully automatic positioning of the shank relative to the base member, which is particularly advantageous for series or mass production.

In a further embodiment the shank has an abutting face which is smaller than 50%, particularly smaller than 45% and preferably smaller than 40% of the supporting face. Particularly when the shank is arranged coaxially with the supporting face of the base member this ensures that, even when the shank is fixed on the base member by its abutting face, the available supporting face is large enough to allow a stable arrangement of the flat component at a spacing from the carrier member.

In another embodiment the shank has means for fixing a flat component. It is particularly advantageous for the shank to have at least one raised portion extending at least partly radially outwards, the raised portion preferably being shaped peripherally as a latching step or screw thread. The function of such latching steps is, for example, to help press the flat component against the supporting face and fix it transversely to that face. However, the latching step or screw thread may equally be used to fix an additional clamping element to the shank and, in the mounted state, to press the flat component against the supporting face of the base member. Some examples which can be mentioned are Christmas tree structures, nuts, transverse pins extending through the shank and the like.

Another aspect of the invention is that methods of producing the fastener described above are stated, particularly one wherein the base member is first produced by a primary shaping or re-shaping and/or a machining process and the shank is then connected to the supporting face of the base member by a jointing technique. The primary shaping process may in particular be a casting or extrusion process. With regard to re-shaping production processes some examples which can be given here are re-shaping under pressure or free forming.

A method of producing fasteners in one piece by solid re-shaping, for example in a pressing process, is particularly preferred.

Alternatively or in addition to the primary shaping or re-shaping techniques mentioned above, it is proposed that preferably the base member or the entire fastener be produced by at least one machining process, for example with the base element of predeterminable height being severed from a rotationally symmetrical or polygonal raw material (for example by sawing) and the reduced cross-section near the fastening face then being formed by drilling or turning. The available machining processes particularly include finishing processes such as grinding.

The shank is preferably formed by a stud bolt, weld stud or the like. If the fastener is of modular construction different materials may for example be used for the shank and the base member. It is also advantageous to use materials of different thermal conductivity, thus as far as possible reducing any heat transfer from the refractory wall to the carrier member.

It is particularly advantageous for the shank to be welded to the base member. This guarantees a durable connection between the shank and the base member even in the event of high thermal and dynamic stresses.

The fastener according to the invention is preferably used for boxing in safety-relevant units by fixing at least one component, for example a non-flammable wall, to a carrier member at a predetermined spacing therefrom, particularly when the carrier member is made of a metallic material. The carrier member is in particular a container wall or a car body component.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of a first embodiment of the fastener for a thick-walled component, in the mounted state;

FIG. 2 is a section through a second embodiment of the fastener;

FIG. 3 is a section through the FIG. 1 embodiment of a thin-walled component in the mounted state;

FIG. 4 is a section through the FIG. 1 embodiment with two thin-walled components in the mounted state;

FIG. 5 is a section through the FIG. 2 embodiment of the fastener;

FIG. 6 is a diagrammatic, perspective view of a base member;

FIG. 7 is a diagrammatic, perspective view of a base member; and

FIG. 8 shows the gradient of forces through the cross-section of a welded-on fastener.

### DETAILED DESCRIPTION OF THE PREFERRED EMBODIMENTS

The following description of the preferred embodiment(s) is merely exemplary in nature and is in no way intended to limit the invention, its application, or uses.

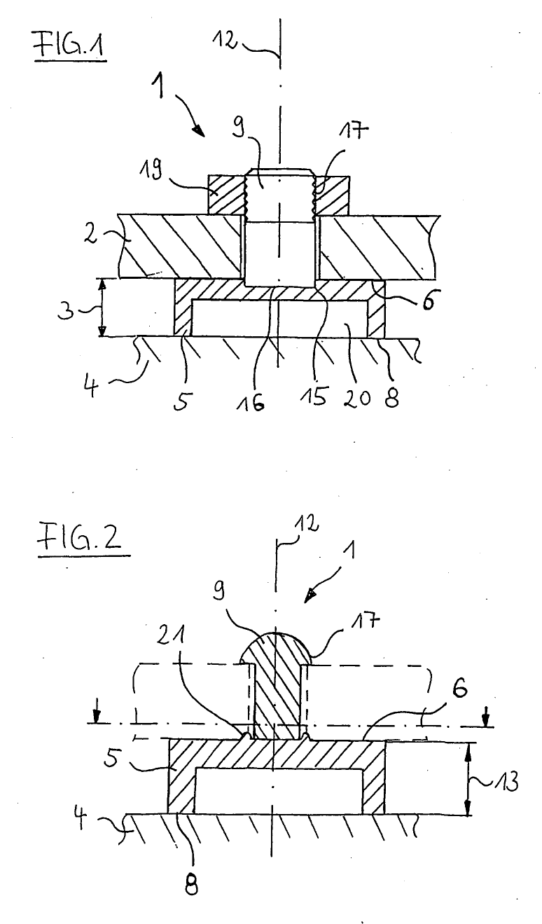

FIG. 1 is a sectional view of a first embodiment of a fastener 1 particularly adapted for fixing a flat, for example thick-walled, component 2 at a spacing 3 from a carrier member 4. The fastener 1 comprises a base member 5 with a supporting face 6 and a fastening face 8. It further comprises a shank 9 arranged on the supporting face 6 of the base member 5 and serving to fix the flat component. In the embodiment illustrated the fastener 1 has a supporting face 6 which is rotationally symmetrical. The fastening face 8 is smaller than the bearing face 6. An annular form of the face 8 is shown in FIG. 1; this shape results in the formation of a cavity 20 internal the base member 5. The fastening face 8 is less than 65% of the supporting face 6.

The fastener 1 is here preferably of modular construction; in addition to the base member 5 and shank 9 it comprises a nut 19, which enables the flat component 2 to be pressed against the supporting face 6 by means of screw thread 17 located on the shank 9. This ensures that the flat component 2 is held permanently in a position spaced 3 from the carrier member 4. The shank 9 is arranged in a recess 15 in the base member 5 coaxially with the axis 12. It further has an abutting face 16 which is smaller than 40% of the supporting face.

FIG. 2 shows an alternative embodiment of the fastener 1 according to the invention. In its mounted state the base member 5 is again connected to the carrier member 4 by the fastening face 8 by a jointing technique, particularly welding. The height 13 of the base member 15 also defines the spacing 3 which is kept between, for example, a refractory wall 2 shown in broken lines and the carrier member 4. To facilitate the positioning of the shank 9 coaxially with the base member 5 the supporting face 6 of the latter has an edge 21 substantially corresponding to the external contour of the shank 9. At the side remote from the base member 5 the shank 9 has a raised portion 17 which is shaped so that the flat component shown in broken lines is pressed against the supporting face 6 of the base member 5 and thus fixed. The raised portion 17 extends radially outwards and is peripheral, ensuring uniform introduction of force into the parts of the flat component in contact with it.

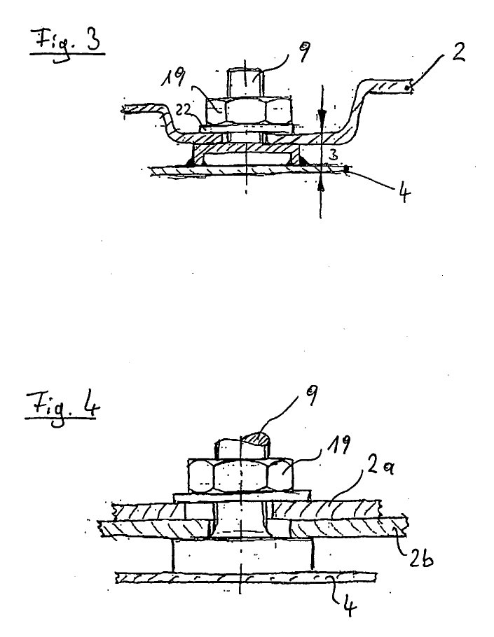

FIG. 3 shows the FIG. 1 embodiment in section, in the mounted state of a thin-walled component 2 which may, for example, also be structured as shown. A washer 22 is arranged between a nut 19 and the thin-walled component 2 to protect the latter. Otherwise the fastener 1 itself is as previously described, advantageously allowing an attachment 2 to be fastened to a welded member 4 at a predeterminable, defined spacing 3.

FIG. 4 shows the FIG. 1 embodiment in section, in the mounted state of two thin-walled components 2a, 2b. As shown clearly in the figure, the relatively generous supporting face 6 has the advantage of not necessarily excluding the mounting of components 2a, 2b with offset holes.

FIG. 5 is a sectional view of the fastener shown in FIG. 2. The base member 5 illustrated has a supporting face 6 with a predeterminable diameter 7. The fastening face 8, shown in broken lines, has an internal diameter 10 and an external diameter 11. The external diameter 11 thereof is equal to the diameter 7 of the supporting face 6. The internal diameter 10 can be chosen to define a fastening face 8 preferably smaller than 65% of the supporting face 6. The shank 9 (not shown) at the centre is arranged with its abutting face 16 in a recess 15 in the base member 5. The abutting face 16 is preferably less then 40% of the supporting face 6.

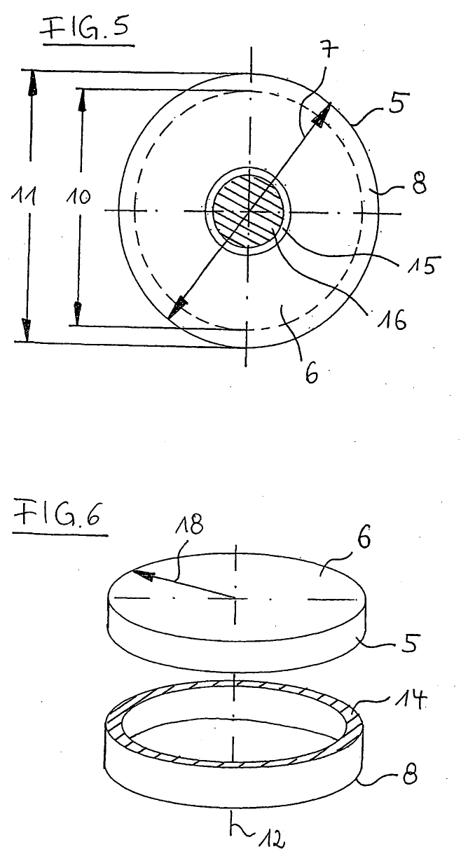

FIG. 6 is a section through one embodiment of the base member 5, shown diagrammatically and in perspective. It will be seen from this figure that the base member 5 has a tube-like portion with a reduced cross-section 14 and a disc-shaped portion with the supporting face 6. The fastening face 8 is located opposite the supporting face 6. The base member 5 is constructed rotationally symmetrically with the axis 12, with the radius 18 perpendicular to the axis 12.

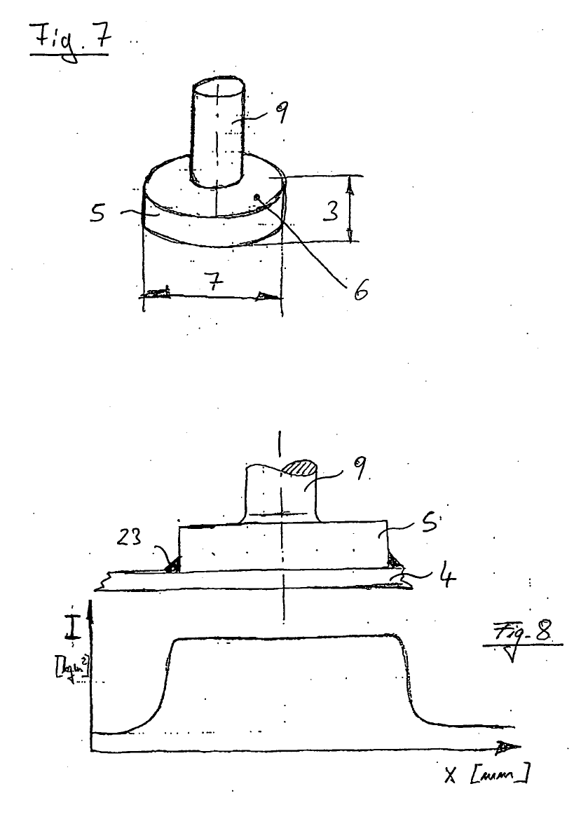

FIG. 7 is a diagrammatic, perspective view of the fastener 1 in a non-mounted state. The advantageous supporting face 6 in particular is clearly visible. The shank 9 is preferably shaped to fit nuts 19, clips, clamps or corresponding fasteners, according to the application.

FIG. 8 shows the rigidity gradient I through the cross-section of a fastener 1 welded on peripherally, diagrammatically in a graph. The preferably peripheral weld 23 is advantageously stiffened, particularly in an application to thin carrier members 4.

The fastener 1 according to the invention is suitable preferably for fixing at least one optionally thin-walled component 2 at a predeterminable spacing 3 from a carrier member 4, particularly when the carrier member 4 is made of a metallic material. The member 4 may for example be a container wall or a car body component.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fastener configured to couple a component having a flat surface at a predetermined spacing from a carrier member comprising:
a base member having a supporting face, a fastening face, and a shank which is arranged on the supporting face and is configured to support the component, the fastening face being generally annular and having a surface area smaller than the supporting face.

2. A fastener according to claim 1, wherein the supporting face and fastening face are rotationally symmetrical.

3. A fastener according to claim 2, wherein the annular fastening face has an internal diameter and an external diameter, the external diameter being equal to the diameter of the supporting face.

4. A fastener according to claim 1, wherein the fastening face is polygonal.

5. A fastener according to claim 1 wherein the fastening face is has a surface area less than 80%, of the supporting face.

6. A fastener according to claim 5 wherein the fastening face is has a surface area less than 65% of the supporting face.

7. A fastener according to claim 1 wherein the base member has a height of between 3 and 10 mm in the direction of an axis.

8. A fastener according to claims 1, wherein the fastener is of modular construction.

9. A fastener according to claim 8, wherein a means is provided for positioning the shank on the supporting face, and the shank is connected to the base member preferably by a jointing technique.

10. A fastener according to claim 1 wherein the shank has an abutting face which is smaller than 50% of the supporting face.

11. A fastener according to any of claims 1 wherein the shank has an abutting face which is smaller than 40% of the supporting face.

12. A fastener according claim 1, characterized in that the shank has a means for fixing a flat component.

13. A fastener according to claim 11, characterized in that the shank has at least one raised portion extending at least partly radially outwards, the at least one raised portion preferably being shaped peripherally as a latching step or screw thread.

14. A method of producing a fastener having a base member with a supporting face, a fastening face, and a shank which is arranged on the supporting face and is configured to support the component, the fastening face being generally annular and having a surface area smaller than the supporting face, wherein the base member is first produced by a primary shaping process and the shank is then connected to the supporting face of the base member by a jointing technique.

15. A method of producing a fastener having a base member with a supporting face, a fastening face, and a shank which is arranged on the supporting face and is configured to support the component, the fastening face being generally annular and having a surface area smaller than the supporting face, wherein the entire fastener is formed by a primary shaping process.

16. A stud to structure construction comprising:
a weldable fastener having a base member having a supporting face, a fastening face, and a shank which is arranged on the supporting face and is configured to support the component, the fastening face being generally annular and having a surface area smaller than the supporting face; and
an annular weldment disposed between and coupling the weldable fastener to the structure.

17. The stud to structure construction according to claim 16 wherein the shank is threaded.

18. The stud to structure construction according to claim 17 wherein the base member comprises a web portion.

19. The stud to structure construction according to claim 16 wherein the fastening face defines an aperture having a first internal diameter which is configured so the fastening face has an area which is less than about 65% of the area of the supporting face.

20. A weld stud configured to couple a component having a flat surface at a predetermined spacing from a carrier member comprising:
a longitudinally elongated shank;
a laterally enlarged head extending from an end of the shank; and
a substantially annular section longitudinally extending from the head opposite the shank; and
wherein a fastening face of the annular section is substantially flat along a lateral plane substantially parallel to a lateral plane of the head, prior to welding and wherein the fastening face defines an aperture having a first internal diameter being configured so the fastening face has an area which is less than about 65% of the area of the supporting face.

21. A weld stud according to claim 20 wherein the shank has an abutting face which is smaller than 50% of the supporting face.

22. A weld stud according to claim 20 wherein the shank has an abutting face which is smaller than 40% of the supporting face.

23. A weld stud according to claim 20 wherein the shank is arranged coaxially with the supporting face and wherein the available supporting face is large enough to allow a stable arrangement of the flat component at a spacing from the carrier member.

24. The weld stud according to claim 20 wherein said head has an exterior wall having a first exterior radius and said annular weldment area has a second exterior radius equal to the first exterior radius.

25. The weld stud according to claim 20 wherein the elongated shank is a threaded shank.

26. An automotive vehicle component construction comprising:
a component having generally planar coupling surface;
a carrier panel; and
a weldable fastener having a base member having a supporting face, a fastening face, and a shank which is arranged on the supporting face and is configured to support the coupling surface component, the fastening face being generally annular and having a surface area smaller than the supporting face; and
an annular weldment disposed between and coupling the weldable fastener to the structure, wherein the ring stud is coupled to the carrier panel by the annular weldment area.

27. The automotive vehicle component construction according to claim 26 wherein the wherein the shank has an abutting face which is smaller than 50% of the supporting face.

28. The automotive vehicle component construction according to claim 26 wherein the shank has an abutting face which is smaller than 40% of the supporting face.

29. The automotive vehicle component construction according to claim 26 wherein the shank is arranged coaxially with the supporting face and wherein the available supporting face is large enough to allow a stable arrangement of the flat component at a spacing from the carrier member.

30. A method of attaching a component at a predetermined distance to an automotive vehicle panel, the method comprising:
(a) locating a fastener having a base member with a supporting face, a fastening face, and a shank which is arranged on the supporting face and is configured to support the component, the fastening face being generally annular and having a surface area smaller than the supporting face, adjacent the vehicle panel;
(b) creating an electrical arc between the fastener and the vehicle panel; and
(c) coupling the component to the fastener at the fastening face.
